(19) United States
(12) Patent Application Publication
(10) Pub. No.: US 2019/0136166 A1
(43) Pub. Date: May 9, 2019

(54) METHOD FOR MAKING SWEET WINE WITH GRAPE FLAVOR, AND SWEET WINE WITH GRAPE FLAVOR

(71) Applicant: Boxing DONG, Yunxiao County, Fujian Province (CN)

(72) Inventor: Boxing DONG, Yunxiao County, Fujian Province (CN)

(21) Appl. No.: 16/306,835

(22) PCT Filed: Jun. 5, 2017
(86) PCT No.: PCT/CN2017/087120

§ 371 Date: Dec. 3, 2018

(30) Foreign Application Priority Data
Jun. 6, 2016 (CN) 201610395131.3

(51) Int. Cl. C12G 1/02

(52) U.S. Cl. CPC C12G 1/02; C12G 2200/21

(57) ABSTRACT

Disclosed are a method for producing a sweet wine with grape flavor, and a sweet wine with grape flavor produced according to the method. The method comprises: placing grapes and jiuqu in a fermenter; keeping a temperature of the fermenter at a fermentation temperature of 25° C. to 38° C., preferably 28° C. to 32° C., for 15 to 40 hours, preferably 18 to 24 hours; adding liquor or spirit into the fermenter, in which an alcohol content of the liquor or spirit is not lower than 15%; sealing the fermenter for 10 to 30 days, preferably 18 to 22 days; and filtering a fermented product in the fermenter to obtain the sweet wine with grape flavor.

### TECHNICAL FIELD

The present disclosure relates to a method for producing a sweet wine, and more specifically to a method for producing a sweet wine with grape flavor, and a sweet wine produced according to the method.

### BACKGROUND ART

Sweet wine or sweet liquor generally refers to a wine or liquor containing 2.5% or more of sucrose or glucose. The sugar in the wine or liquor is generally derived from the brewing material of the wine or liquor, i.e., a sugar which is originally present in the brewing material, and a sugar which may be derived from the hydrolysis of starch or polysaccharide in the brewing material.

During the brewing process, the sugar is gradually converted into alcohol, which increases the alcohol content of the wine or liquor and reduces the sugar content thereof. Therefore, a wine or liquor that is sufficiently fermented and/or distilled has low sugar content; for example, liquor and spirits, beer, and wine, which are commonly found in the market, have low sugar content and thus do not have obvious mouthfeel of sweet taste.

In order to obtain a unique mouthfeel of both high alcohol content and high sugar content, the sugar can be added into a strong liquor, or a strong liquor can be mixed with a partially fermented liquor having a higher sugar content. However, the addition of the sugar into the strong liquor suffers from difficulty in dissolving and mixing, while the mixing of the strong liquor with the liquor having higher sugar content has the disadvantages that the mouthfeel is inharmonious and the sugar content is still insufficient.

In order to solve the above problems, the present disclosure provides a special method for producing a wine by combining the process of producing liquor and spirits with the process of producing wine, wherein the unique property of natural fermentation of the grapes is not used for the production, but the grapes are mixed with jiuqu to perform jiuqu fermentation for a short period, then a liquor or spirit is added therein and the resulting product is standing for a long period, while the sugar in the grapes are sufficiently retained, thereby obtaining a sweet wine with grape flavor that has high sweetness and harmonious taste.

### SUMMARY

The present disclosure refers to a method for producing a sweet wine with grape flavor, and the method comprises:

placing grapes and jiuqu in a fermenter:

keeping a temperature of the fermenter at a fermentation temperature of 25° C. to 38° C., preferably 28° C. to 32° C., most preferably 30° C., for 15 to 40 hours, preferably 18 to 24 hours, most preferably 20 hours;

adding liquor or spirit into the fermenter, in which an alcohol content of the liquor or spirit is not lower than 15%, preferably not lower than 40%, further preferably not lower than 50%, most preferably 58%;

sealing the fermenter for 10 to 30 days, preferably 18 to 22 days, further preferably 20 days; and

filtering a fermented product in the fermenter to obtain the sweet wine with grape flavor.

In some embodiments of the present disclosure, the method according to the present disclosure further comprises placing grape stems together with the grapes and the jiuqu in the fermenter.

In some embodiments of the present disclosure, during the process of “keeping a temperature of the fermenter at a fermentation temperature”, the fermenter could partially communicate with ambient atmosphere.

In some embodiments of the present disclosure, the method according to the present disclosure further comprises a step of washing the grapes with warm water and drying the washed grapes before placing the grapes in the fermenter.

In some embodiments of the present disclosure, the method according to the present disclosure further comprises a step of washing the grape stems with warm water and drying the washed grape stem before placing the grape stems in the fermenter.

In some embodiments of the present disclosure, the weight ratio of the grapes to the grape stems is from 5:1 to 20:1, preferably from 8:1 to 12:1, and most preferably about 10:1.

In some embodiments of the present disclosure, the jiuqu is maiqu, xiaoqu, hongqu, daqu or fuqu.

In some embodiments of the present disclosure, the weight ratio of the grapes to the jiuqu is from 100:4 to 100:10, preferably from 100:5 to 100:9, and most preferably 100:8.

In some embodiments of the present disclosure, the fermenter can be a ceramic container, a glass container, a stainless steel container, an oak barrel, or other containers that can be used in brewing, preferably a ceramic container or an oak barrel.

In some embodiments of the present disclosure, the liquor or spirit can be fuyu-flavor liquor or spirit, jiang-flavor liquor or spirit, nong-flavor liquor or spirit, mild-flavor liquor or spirit, mi-flavor liquor or spirit, sesame-flavor liquor or spirit, mixed-flavor liquor or spirit, or feng-flavor liquor or spirit.

In some embodiments of the present disclosure, the weight ratio of the grapes to the liquor or spirit is from 1:2 to 2:1, preferably from 1:1.5 to 1.5:1, further preferably from 1:1.2 to 1.2:1, and most preferably 1:1.

In some embodiments of the present disclosure, the method according to the present disclosure further comprises partially crushing the grapes before placing the grapes in the fermenter.

The present disclosure further relates to a sweet wine with grape flavor produced according to the method of the present disclosure.

Some other embodiments of the present disclosure further comprises a wine obtained by blending the sweet wine with grape flavor produced according to the method of the present disclosure with additional additives, wherein the additional additives include but not limited to food additives such as saccharides, flavoring agents, preservatives and the like.

### DETAILED DESCRIPTION

The following examples disclose some exemplary embodiments of the present disclosure to assist in understanding the technical solutions of the present disclosure, but it should be understood that the disclosure is not limited to the following examples.

### Example 1

In a specific embodiment of the present disclosure, a sweet wine with grape flavor was produced by the following steps:

100 kg of grapes of Fu'an Kyoho grape, 10 kg of grape stems and 0.8 kg of xiaoqu were placed in a stainless steel fermenter;

the temperature of the fermenter was kept at a fermentation temperature of 30° C. for 20 hours;

100 kg of homemade 52-degree rice liquor was added into the fermenter;

the fermenter was sealed and stood for 20 days; and

the sweet wine with grape flavor was obtained after filtering the fermented product in the fermenter.

### Example 2

In another specific embodiment of the present disclosure, a sweet wine with grape flavor was produced by the following steps:

0.5 kg of grapes of Fu'an Kyoho grape and 2 g of maiqu were placed in a 20-liter ceramic fermenter;

the temperature of the fermenter was kept at a fermentation temperature of 33° C. for 30 hours;

0.75 kg of 42-degree Luzhou Lao Jiao touqu nong-flavor liquor was added into the fermenter;

the fermenter was sealed and stood for 28 days; and

the sweet wine with grape flavor was obtained after filtering the fermented product in the fermenter.

By using the sweet wines produced by the above method and a reinforced wine (Lillet wine), a double-blind test was conducted among 30 Chinese consumers who liked drinking liquor or spirit, and the following evaluation results were obtained:

| The number of people who answered | | | |
|---|---|---|---|
| yes to the following questions | Example 1 | Example 2 | Lillet wine |
| “This kind of wine belongs to liquor | 23/30 | 25/30 | 0/30 |
| or spirit” | | | |
| “This kind of wine belongs to grape | 3/30 | 2/30 | 25/30 |
| wine” | | | |
| “I prefer this kind of wine” | 10/30 | 15/30 | 5/30 |
| “This kind of wine tastes sweeter” | 12/30 | 15/30 | 3/30 |
| “This kind of wine has bitter | 0/30 | 0/30 | 0/30 |
| mouthfeel” | | | |
| “The mouthfeel of this kind of wine | 30/30 | 30/30 | 30/30 |
| is harmonious and well-acceptable” | | | |

The sweet wines with grape flavor produced according to the above embodiments of the present disclosure have the following significant differences compared to the reinforced wine (Lillet wine):

1. The sweet wines of the present disclosure have higher sweetness (generally higher than 60 g/L, and may be higher than 70 g/L, even higher than 80 g/L);

2. The sweet wines of the present disclosure have a taste consistent with that of liquor and spirit and possess slight grape aroma. They generally belong to the taste and aroma of grain liquor and spirits; however, Lillet wine has a consistent grape flavor and belongs to the taste and aroma of fruit wine; and

3. Drinkers who are accustomed to grain liquor and spirits in China prefer the sweet wine according to the present disclosure, and do not favor Lillet wine.

The grape fermentation process of the present disclosure relies on the addition of jiuqu, which is totally different from the process that relies on the natural fermentation of grapes in the traditional brewing technology of wine. Therefore, unlike the need to completely crush the grapes in the traditional process, it is substantially unnecessary to crush the grapes in the present disclosure or it is possible to partially crush the grapes, in order to ferment together with the jiuqu. In such way, most of sugar in the grapes is retained, resulting in higher sugar content in the final sweet wine. The final sweet wine does not have the taste formed by the fermentation of the grapes, but possesses the consistent liquor or spirit mouthfeel formed by the fermentation with the jiuqu and meanwhile has the aroma of the grapes (the aroma of the unfermented or less fermented grapes).

In addition, the sweet wine according to the present disclosure does not need the addition of additional additives except the jiuqu and liquor or spirit during the brewing process, and does not need SO₂ which is usually added during the general fermentation process of grape wine. Therefore, from the viewpoint of the taste or content, the sweet wine of the present disclosure is totally different from the grape wine, and suitable for consumers with different habits.

The grape stems contain rich potassium element, which can maintain the homeostasis and the normal neuromuscular function of the human. In some embodiments of the present disclosure, the grape stems and the grapes are used together as the materials for producing wine, and the sweet wine with good mouthfeel and rich nutrient is obtained. In contrast, the grape stems are discarded in the grape wine manufacturing processes.

1. A method for producing a sweet wine with grape flavor comprises:
placing grapes and jiuqu in a fermenter;
keeping a temperature of the fermenter at a fermentation temperature of 25° C. to 38° C. for 15 to 40 hours;
adding liquor or spirit into the fermenter, in which an alcohol content of the liquor or spirit is not lower than 15%;
sealing the fermenter for 10 to 30 days; and
filtering a fermented product in the fermenter to obtain the sweet wine with grape flavor.

2. The method of claim 1 further comprises placing grape stems together with the grapes and the jiuqu in the fermenter.

3. The method of claim 1, wherein during the process of “keeping a temperature of the fermenter at a fermentation temperature”, the fermenter partially communicates with ambient atmosphere.

4. The method of claim 1 further comprises a step of washing the grapes with warm water and drying the washed grapes before placing the grapes in the fermenter.

5. The method of claim 2 further comprises a step of washing the grape stems with warm water and drying the washed grape stems before placing the grape stems in the fermenter.

6. The method of claim 1, wherein the jiuqu is maiqu, xiaoqu, hongqu, daqu or fuqu.

7. The method of claim 1, wherein the liquor or spirit is fuyu-flavor liquor or spirit, jiang-flavor liquor or spirit, nong-flavor liquor or spirit, mild-flavor liquor or spirit, mi-flavor liquor or spirit, sesame-flavor liquor or spirit, mixed-flavor liquor or spirit, or feng-flavor liquor or spirit.

8. The method of claim 1, wherein the alcohol content of the liquor or spirit is not lower than 50%.

9. The method of claim 1 further comprises partially crushing the grapes before placing the grapes in the fermenter.

10. A sweet wine with grape flavor produced according to the method of claim 1.

11. The method of claim 1, wherein the temperature of the fermenter is kept at a fermentation temperature of 28° C. to 32° C.

12. The method of claim 1, wherein the temperature of the fermenter is kept at a fermentation temperature for 18 to 24 hours.

13. The method of claim 1, wherein the fermenter is sealed for 18 to 22 days.

14. A sweet wine with grape flavor produced according to the method of claim 2.

15. A sweet wine with grape flavor produced according to the method of claim 9.
